(19) United States
(12) Patent Application Publication
(10) Pub. No.: US 2003/0159699 A1
(43) Pub. Date: Aug. 28, 2003

(54) Patient-positioning method and system

(75) Inventors: Barry G. Anderson, Sheboygan, WI (US); John W. Seaman, Sheboygan Falls, WI (US); Robert K. Vander Schaaf, Sheboygan Falls, WI (US)

Correspondence Address: MICHAEL BEST & FRIEDRICH, LLP, 100 E WISCONSIN AVENUE, MILWAUKEE, WI, 53202, US

(73) Assignee: Bemis Manufacturing Company, Sheboygan Falls, WI

(21) Appl. No.: 10/085,289

(22) Filed: Feb. 28, 2002

(51) Int. Cl. A61G 15/00

(52) U.S. Cl. 128/845

(57) ABSTRACT

A patient positioning device including a main portion and a hanging tab connected to the main portion. A method and apparatus for a patient-positioning device system including several patient-positioning devices and a storage rack.

### BACKGROUND OF THE INVENTION

The invention relates generally to patient-positioning devices used in health care.

Clinicians often need to secure a portion of a patient's body in a certain position for an extended period of time, such as during a prolonged medical procedure, when a patient is bedridden, or when an injured portion of a patient's body is healing. During a prolonged medical procedure or when a patient is bedridden, a patient can develop sores, and can even experience nerve damage, at pressure points where the patient's body is in contact with the surgical table or the hospital bed. For example, the patient's head, elbows, and heels become pressure points where sores and nerve damage often occur. Also, when an injured portion of a patient's body is healing, the injured portion may need support and protection in order to avoid re-injury.

Blankets or towels are often used by clinicians to secure a patient's body in a certain position. However, blankets and towels must be folded or rolled into suitable shapes that generally do not adequately secure the patient in the particular position. Especially for prolonged medical procedures, blankets and towels cannot adequately secure a patient's body so that the patient's body is stationary during the entire procedure. Also, blankets and towels must be washed after each use which adds to the laundry costs of the hospital or clinic.

Patient-positioning devices are used by clinicians in order to more securely position portions of a patient's body. Conventional patient-positioning devices generally consist of sheets of resilient foam or blocks of resilient foam in particular shapes. For example, a circular block of foam with a hole in the center, called a “donut” or a “bagel,” is often used to relieve pressure under a patient's head. Conventional patient-positioning devices generally must be discarded after each use, so that bodily fluids and other contaminates are not transferred from patient to patient. Since conventional patient-positioning devices are not reusable, an inventory of patient-positioning devices must be kept, which requires additional storage space in hospitals and clinics.

Conventional patient-positioning devices are generally stored in cabinets or drawers in hospitals and clinics. Particularly in operating rooms during surgical procedures, clinicians often cannot quickly and easily access patient-positioning devices that are stored in a cabinet or drawer.

### SUMMARY OF THE INVENTION

The invention provides a patient-positioning device including a hanging tab, so that the patient-positioning device can be stored in a hanging position.

The invention also provides a patient-positioning device system including a plurality of patient-positioning devices and a storage rack from which the patient-positioning devices can be hung. The storage rack preferably includes a base member that can be mounted to a wall in a hospital or clinic. Several prongs from which the patient-positioning devices can be hung are preferably connected to the base member. The patient positioning devices can be hung, preferably via their hanging tabs, from the prongs.

The invention further provides an elbow protector patient-positioning device that is configured to support a portion of a patient's arm. The elbow protector includes a circular aperture configured to receive the patient's elbow.

The invention still further provides a heel protector patient-positioning device that is configured to support the lower calf and heel portions of a patient's leg. The heel protector preferably includes a main portion having a medial portion, a first lateral support connected to the medial portion via a first offset portion, and a second lateral support connected to the medial portion opposite to the first lateral support via a second offset portion. A circular aperture is formed through the medial portion and is configured to receive the patient's heel. A securement strap can be coupled between the first and second lateral supports in order to secure the patient's heel within the circular aperture and in order to secure the first and second lateral supports around the lower calf and heel portions of a patient's leg.

For the method of the invention, a plurality of patient-positioning devices are hung on a storage rack. Before a clinician performs a medical procedure on a portion of a patient's body, the clinician removes one of the patient-positioning devices from the storage rack and positions the patient-positioning device under the particular portion of the patient's body. Once the clinician completes the medical procedure, the clinician removes the patient-positioning device from under the portion of the patient's body and hangs the patient-positioning device, preferably via its hanging tab, from the storage rack.

Various other features and advantages of the invention are set forth in the following drawings, detailed description and claims.

### BRIEF DESCRIPTION OF THE DRAWINGS

FIG. 1 is a perspective view of a patient-positioning device system embodying the invention;

FIG. 2 is a partial, cross-sectional view of a patient-positioning device;

FIG. 3 is a perspective view of a small bagel patient-positioning device;

FIG. 4 is a perspective view of a large bagel patient-positioning device;

FIG. 5 is a perspective view of a patient's head positioned on the large bagel patient-positioning device of FIG. 4;

FIG. 6 is a perspective view of an elbow protector patient-positioning device;

FIG. 7 is a perspective view of a patient's arm positioned on the elbow protector of FIG. 6;

FIG. 8 is a top plan view of the elbow protector of FIG. 6;

FIG. 9 is a side elevational view of the elbow protector of FIG. 6;

FIG. 10 is an end elevational view of the elbow protector of FIG. 6;

FIG. 11 is a perspective view of a heel protector patient-positioning device;

FIG. 12 is a side elevational view of the heel protector of FIG. 11;

FIG. 13 is a top plan view of the heel protector of FIG. 11;

FIG. 14 is an end elevational view of the heel protector of FIG. 11;

FIG. 15 is a perspective view of a patient's foot positioned in the heel protector of FIG. 11;

FIG. 16 is a side elevational view of a patient's foot positioned in the heel protector of FIG. 11;

FIG. 17 is a perspective view of a non-slotted patient-positioning device;

FIG. 18 is a perspective view of a patient's head positioned on the non-slotted patient-positioning device of FIG. 17;

FIG. 19 is a perspective view of a slotted patient-positioning device;

FIG. 20 is a perspective view of a patient's head positioned on the slotted patient-positioning device of FIG. 19;

FIG. 21 is a perspective view of chest roll patient-positioning device;

FIG. 22 is a perspective view of a patient's head positioned on the slotted patient-positioning device of FIG. 19 and the patient's arm positioned on the chest roll of FIG. 21; and

FIG. 23 is a perspective view of the large bagel of FIG. 4 positioned within a disposable protective cover.

### DETAILED DESCRIPTION OF THE INVENTION

Before one embodiment of the invention is explained in full detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including” and “comprising” and variations thereof herein is meant to encompass the items listed thereafter and equivalents thereof as well as additional items.

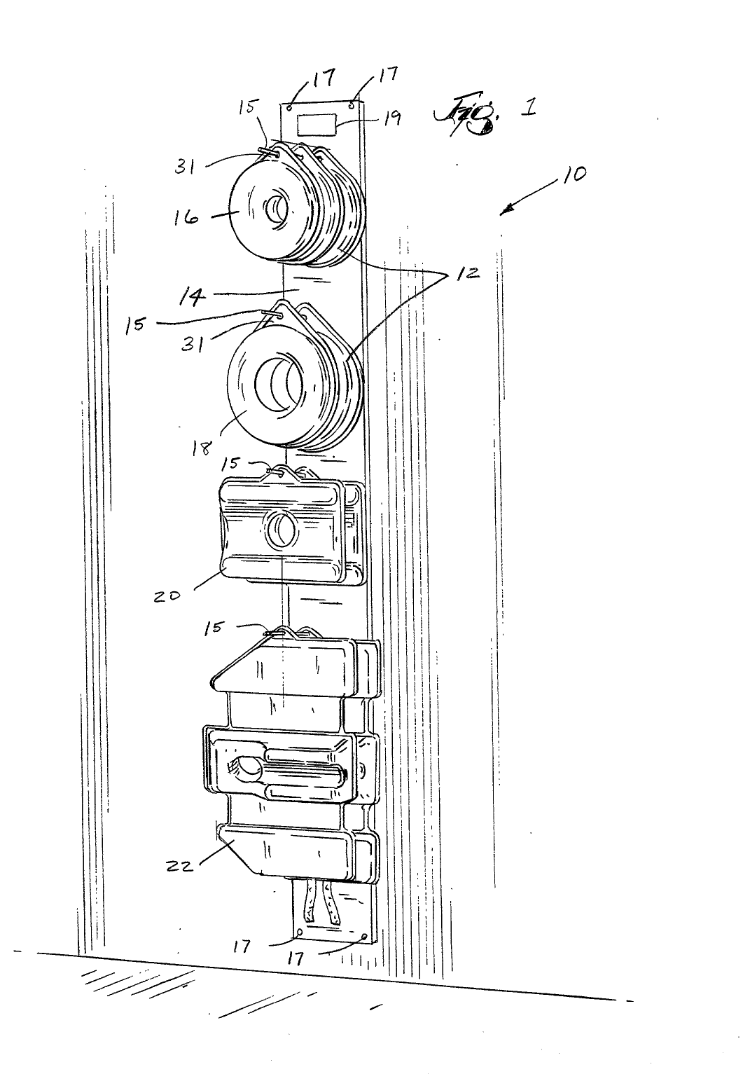

FIG. 1 illustrates a patient-positioning device system 10 embodying the invention. The patient-positioning device system 10 includes several patient-positioning devices 12 and a storage rack 14. Each of the different types of patient-positioning devices 12 illustrated in FIG. 1 has a different shape or configuration suitable for positioning different portions of a patient's body. The types of patient-positioning devices 12 illustrated in FIG. 1 include small bagels 16, large bagels 18, elbow protectors 20, and heel protectors 22. Although the patient-positioning device system 10 is shown as including only four types of patient-positioning devices 12, the patient-positioning device system 10 can include any number and any type of patient-positioning devices 12.

The storage rack 14 preferably includes prongs 15 spaced apart from one another proportionally along the length of the storage rack 14. However, the storage rack 14 can include any suitable number of prongs 15 in any suitable configuration to accommodate the patient-positioning devices 12 included in the patient-positioning device system 10. Also, the storage rack 14 can have any suitable shape to accommodate the patient-positioning devices 12, such as a square-shape with two or more horizontal rows of prongs 15. The prongs 15 are preferably approximately 4 to 5 inches long so that more than one patient-positioning device 12 can be hung from each prong 15. The storage rack 14 preferably includes mounting holes 17 in each one of its four comers. The mounting holes 17 are configured to receive bolts or screws in order to secure the storage rack 14 to a wall in a hospital or clinic. The storage rack 14 can also be hung from the wall of the hospital or clinic in any manner found suitable by the maintenance staff of the hospital or clinic. The storage rack 14 can also include one or more labels 19 with a description of each one of the patient-positioning devices 12 included in the patient-positioning device system 10. In general, the storage rack 14 is designed to provide clinicians with convenient access to the patient-positioning devices 12, especially in an environment such as an operating room.

As shown in FIG. 2, each one of the patient-positioning devices 12 includes a main portion constructed of a block of resilient material 24. The block of resilient material 24 is preferably encapsulated by a substantially impermeable cover 26. The block of resilient material 24 is preferably constructed of high-density, closed-cell foam. However, the block of resilient material 24 can be constructed of any material that is capable of conforming to a patient's body and then returning to its original shape.

The impermeable cover 26 includes a top portion 28 connected to a bottom portion 30 by a seal 32. The top portion 28 includes a substantially-horizontal top surface 34 and substantially-vertical side surfaces 36. The impermeable cover 26 is preferably constructed of a highly-flexible, stain-resistant, water-proof material, such as a viscoelastic polymeric material. For example, latex-free vinyl can be used for the impermeable cover 26. Preferably, the latex-free vinyl also contains antimicrobial agents to help prevent the growth of bacteria on the patient-positioning device 12. In addition, the impermeable cover 26 can be constructed of more than one material or more than one layer of material. The impermeable cover 26 is also preferably a bright color in order to help prevent against unintentional disposal.

The seal 32 between the top portion 28 and the bottom portion 30 of the impermeable cover 26 is preferably formed using heat seal technology in which the top portion 28 is electrically sealed or welded to the bottom portion 30. By using heat seal technology, the resulting seal 32 is water-proof. The seal 32 also preferably has a relatively large width in order to help prevent contaminates from becoming trapped in the seal 32 and in order to allow the seal 32 to be cleaned easily. The width of the seal 32 positioned around the perimeter of each one of the patient-positioning devices 12 is preferably equal to or greater than approximately 0.12 inches.

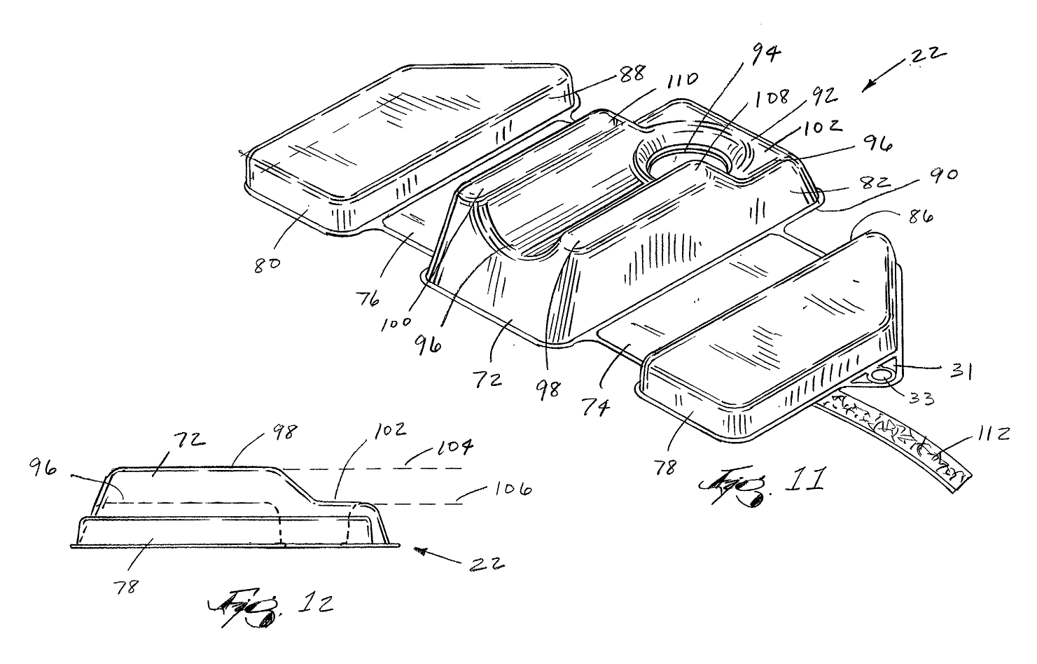

Each one of the patient-positioning devices 12 shown in FIGS. 1-23 includes a hanging tab 31. The hanging tab 31 can be a hook, a string, a cord, or any other device that can extend from or be connected to the patient-positioning device 12 and that is suitable for supporting the weight of the patient-positioning device 12 in a hanging position. The hanging tab 31 preferably extends from the impermeable cover 26 and is constructed of a sheet of the same material as the impermeable cover 26 with an eyelet 33. The hanging tab 31 is also preferably integrally molded using heat seal technology to the impermeable cover 26, so that the hanging tab 31 is integral with the seal 32. The hanging tab 31 can extend from each one of the different types of patient-positioning devices 12 in any position suitable for supporting the weight of the particular patient-positioning device 12 in a hanging position.

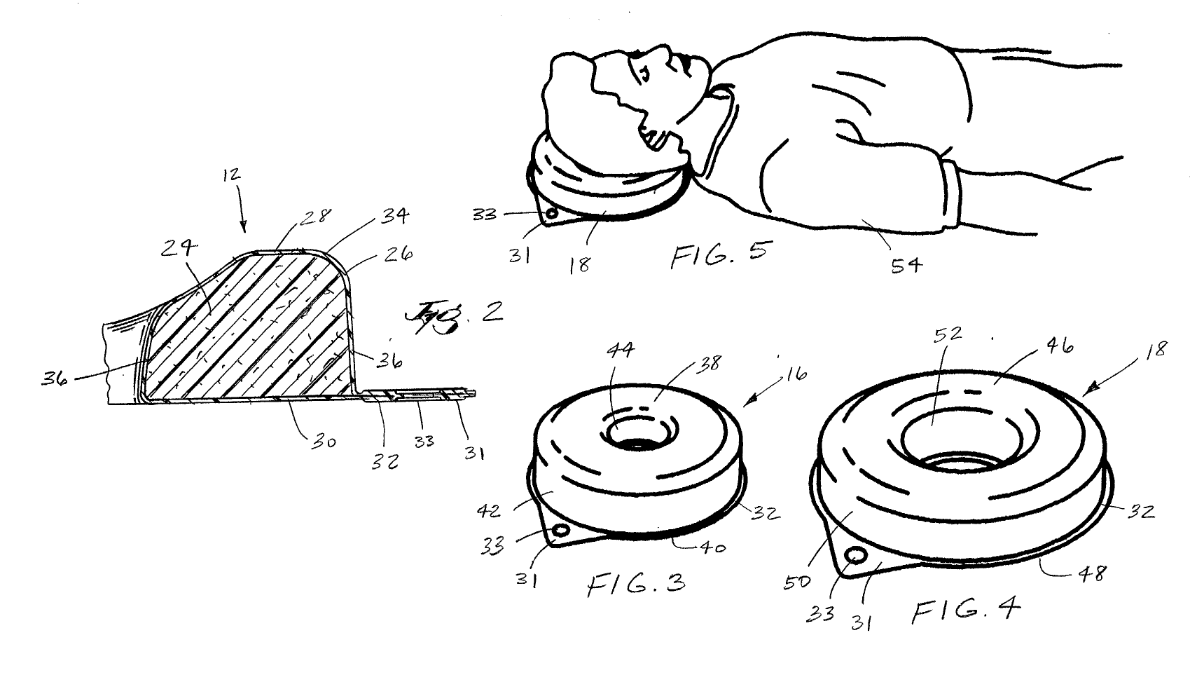

As shown in FIG. 3, the small bagel 16 of the patient-positioning device system 10 includes a main portion comprised of a circular block of resilient material 38 having a bottom side 40 and an upper side 42. A circular aperture 44 is formed through the block of resilient material 38. The bottom side 40 has a substantially flat surface suitable for resting on an operating room table, an examination table, or a hospital bed. The upper side 42 is configured to support a portion of a patient, such as the patient's head when the patient is lying on his or her back (i.e., in the supine position). When positioned under the patient's head, the small bagel 16 relieves pressure from the back of the patient's head. The small bagel 16 can also be used to support a patient's head while the patient is lying on his or her side, so that one of the patient's ears is positioned in the circular aperture 30. The small bagel 16 is particularly suitable for use in positioning a child's head. In addition to being positioned under a patient's head, the small bagel 16 can be used to position other portions of a patient's body as found necessary by a clinician. For example, the small bagel 16 can be positioned under a patient's back to tilt the patient to one side. The small bagel 16 is preferably seven inches in diameter, and can be referred to as a “seven-inch bagel.”

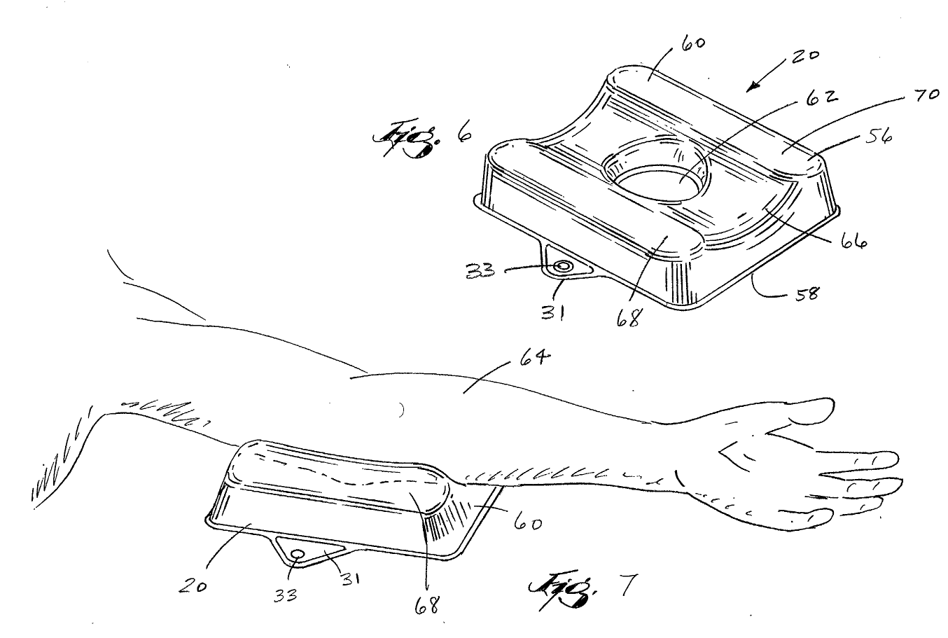

Similar to the small bagel 16, the large bagel shown in FIG. 4 includes a main portion comprised of a circular block of resilient material 46 having a bottom side 48 and an upper side 50. A circular aperture 52 is formed through the block of resilient material 46. The bottom side 48 has a substantially flat surface suitable for resting on an operating room table, an examination table, or a hospital bed. As shown in FIG. 5, the upper side 50 is configured to support a portion of a patient 54, such as the patient's head when the patient 54 is lying on his or her back (i.e., in the supine position). When positioned under the patient's head, the large bagel 18 relieves pressure from the back of the patient's head. The large bagel 18 can also be used to support a patient's head while the patient is lying on his or her side, so that one of the patient's ears is positioned in the circular aperture 52. The large bagel 18 is particularly suitable for use in positioning an adult's head. In addition to being positioned under a patient's head, the large bagel 18 can also be used to position other portions of a patient's body as found necessary by a clinician. The large bagel 18 is preferably nine inches in diameter, and can be referred to as a “nine-inch bagel.”

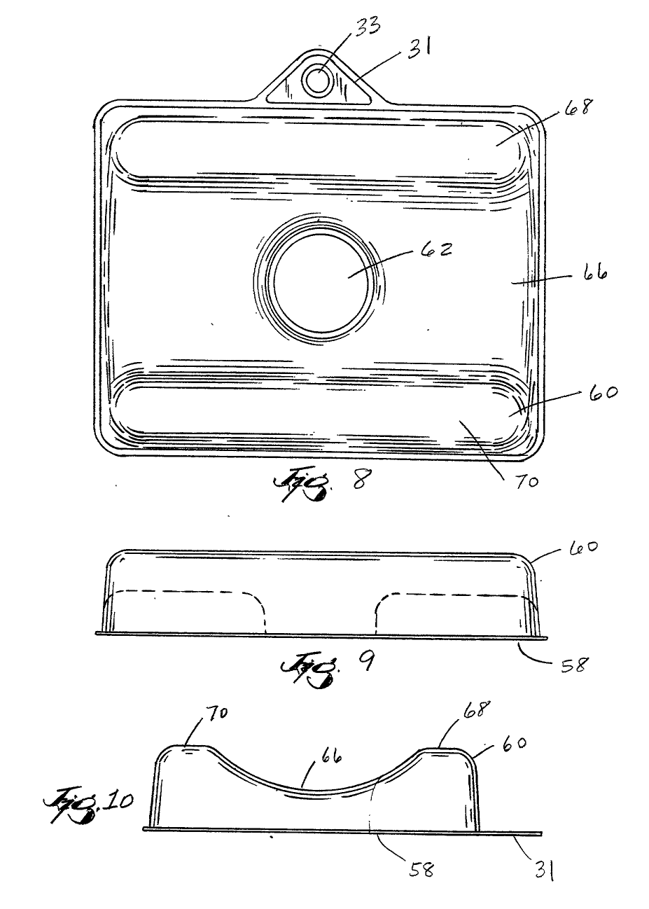

As shown in FIGS. 6-10, the elbow protector 20 includes a main portion comprised of a generally square or rectangular block of resilient material 56 having a bottom side 58 and an upper side 60. A circular aperture 62 is formed through the block of resilient material 56. The bottom side 58 has a substantially flat surface suitable for resting on an operating room table, an examination table, or a hospital bed. As shown in FIG. 7, the upper side 60 is configured to support a patient's out-stretched arm 64 with the patient's elbow positioned in the circular aperture 62. As shown in FIGS. 6 and 8-10, the upper side 60 includes a contoured portion 66 located between a first flat portion 68 and a second flat portion 70. While the patient's elbow is positioned in the circular aperture 62, the patient's forearm and the patient's upper arm are positioned in the contoured portion 66. In addition to being positionable under a patient's arm, the elbow protector 20 can also be used to position other portions of a patient's body as found necessary by a clinician. For example, the elbow protector 20 can be positioned under a patient's knee when the patient is lying on his or her stomach (i.e., in the prone position).

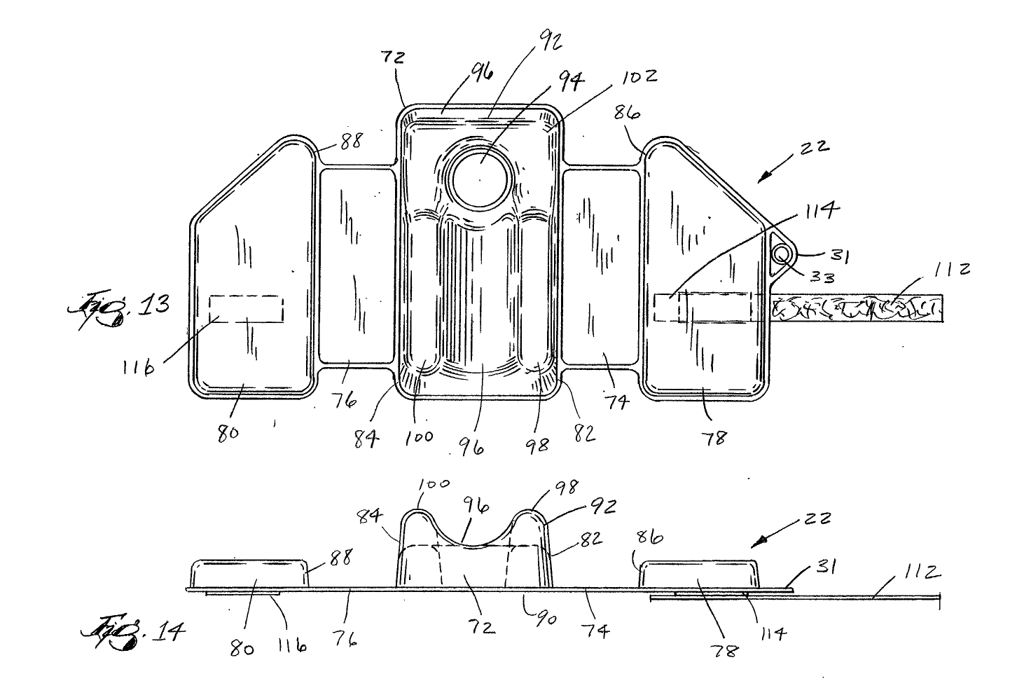

As shown in FIGS. 11-16, the heel protector 22 includes a main portion having a medial portion 72, a first offset portion 74, a second offset portion 76, a first lateral support 78, and a second lateral support 80. The first offset portion 74 is connected to a first side 82 of the medial portion 72, while the second offset portion 76 is connected to a second, opposite side 84 of the medial portion 72. The first offset portion 74 is also connected to a first side 86 of the first lateral support 78, and the second offset portion 76 is also connected to a first side 88 of the second lateral support 80. The medial portion 72, the first lateral support 78, and the second lateral support 80 are each comprised of a generally rectangular block of resilient material.

The impermeable cover 26 encapsulates the medial portion 72, the first lateral support 78, and the second lateral support 80. The first offset portion 74 and the second offset portion 76 are preferably each constructed of a sheet of the same material used to construct the impermeable cover 26. However, the first offset portion 74 and the second offset portion 76 can also be constructed of any other material suitable for coupling the medial portion 72 to the first lateral support 78 and to the second lateral support 80.

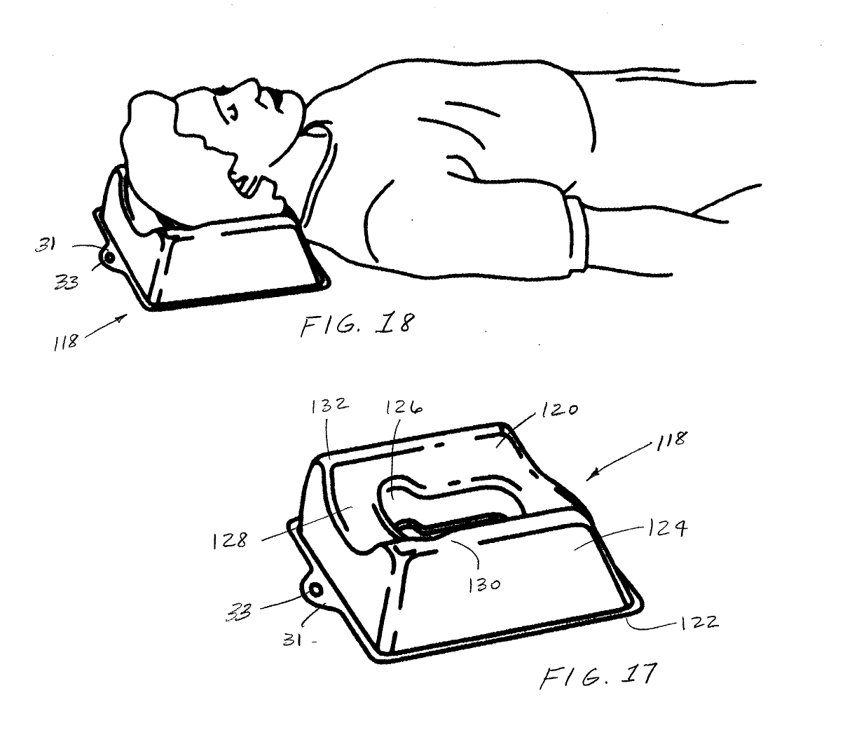

The medial portion 72 includes a bottom side 90 and an upper side 92. A circular aperture 94 is formed through the medial portion 72 in an end 96 of the medial portion 72 that is positioned away from the center of the patient's body (i.e., a distal end). The bottom side 90 has a substantially flat surface suitable for resting on an operating room table, an examination table, or a hospital bed. As shown in FIGS. 15 and 16, the upper side 92 of the medial portion 72 is configured to support a patient's lower calf when the patient's heel is positioned in the circular aperture 94.

Specifically, as shown in FIGS. 11-14, the upper side 92 of the medial portion 72 includes a contoured portion 96 located between a first flat portion 98 and a second flat portion 100. The upper side 92 also includes a third flat portion 102 at the distal end 96 that extends around the perimeter of the circular aperture 94. As best shown in FIG. 12, the first flat portion 98 and the second flat portion 100 each lie in a first plane 104, and the bottom of the contoured portion 96 and the third flat portion 102 each lie in a second plane 106. As best shown in FIG. 11, the first flat portion 98 includes a distal end 108 and the second flat portion 100 includes a distal end 110. The distal end 108 and the distal end 110 each slope downward toward the third flat portion 102.

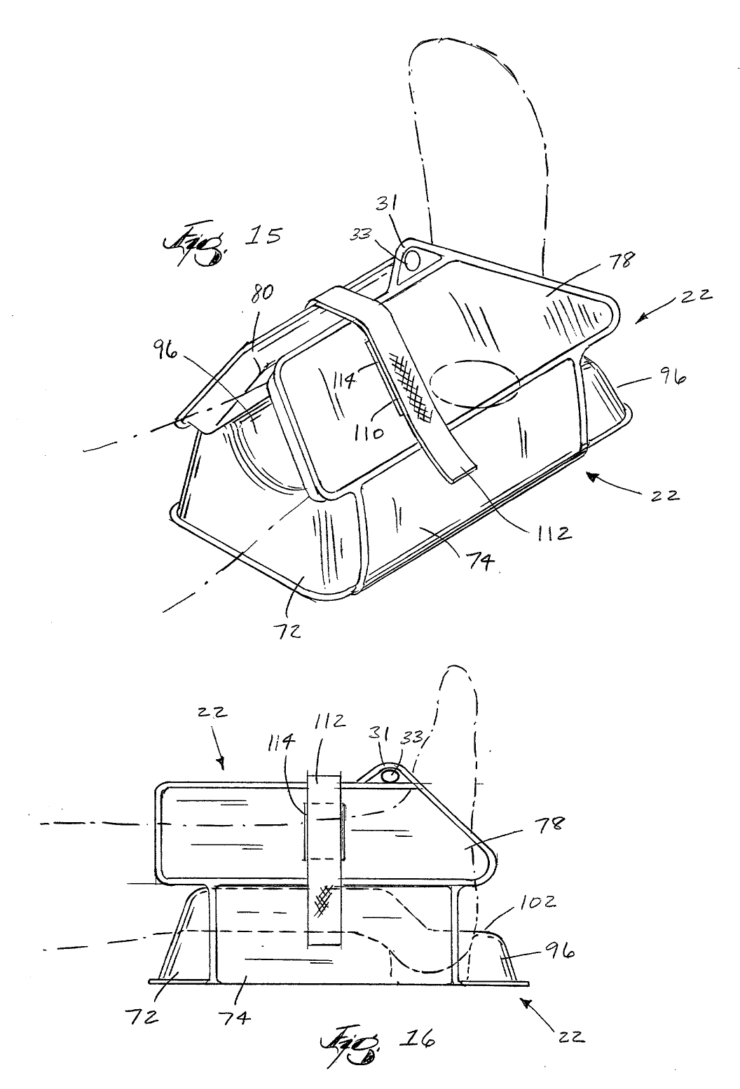

The heel protector 22 also preferably includes a securement strap 112. The securement strap 112 can be constructed of any type of cloth, plastic, synthetic or otherwise suitable material. Preferably, as shown in FIGS. 13 and 14, the securement strap 112 is a strip of hook-and-loop fastener material that is securely connected to a first hook-and-loop fastener patch 114 attached to the first lateral support 78 and can be releasably connected to a second hook-and-loop fastener patch 116 attached to the second lateral support 80. In other embodiments, the securement strap 112 can include a first portion securely fastened to the first lateral support 78 and a second portion securely fastened to the second lateral support 80. The free ends of the first and second portions can then be tied, buckled, snapped or buttoned together. In still other embodiments, the securement strap 112 can be securely fastened to either the first lateral support 78 or the second lateral support 80 and snapped, buttoned, clasped, or otherwise releasable connected to the other of the first lateral support 78 and the second lateral support 80. Moreover, the securement strap 112 could be a length of material that is simply tied around the entire heel protector 22 and the patient's lower calf.

When the heel protector 22 is in use, as shown in FIGS. 15 and 16, the patient's heel is positioned in the circular aperture 94 and the patient's lower calf is positioned in the contoured portion 96. The first lateral support 78 and the second lateral support 80 are wrapped around the patient's lower calf. The first offset portion 74 raises the first lateral support 78 above the level of the first plane 104 of the first flat portion 98. Similarly, the second offset portion 76 raises the second lateral support 80 above the level of the first plane 104 of the second flat portion 100. The securement strap 112 is wrapped around the first lateral support 78 and secured to the hook-and-loop fastener patch 116 on the second lateral support 80. In general, the heel protector 22 is used to ease the muscles of a patient's leg so that pressure points do not form on the patient's heel during a prolonged medical procedure. The heel protector 22 can also support a patient's lower calf and heel so that the patient can roll onto his or her side.

Although not shown on the storage rack 14 in FIG. 1, other types of patient-positioning devices 12 can be included in the patient-positioning device system 10. For example, as shown in FIGS. 17 and 18, the patient-positioning device system 10 can include a non-slotted positioner 118. The non-slotted positioner 118 includes a main portion comprised of a generally square or rectangular block of resilient material 120 having a bottom side 122 and an upper side 124. A T-shaped aperture 126 is formed through the block of resilient material 120. The T-shaped aperture 126 is configured to receive the patient's nose and eyes when the patient is lying on his or her stomach (i.e., in the prone position). The T-shaped aperture 126 is also configured to receive breathing or drainage tubes (e.g., an endotracheal tube) that may be placed in the patient's nose or mouth when the patient is in the prone position. The bottom side 122 has a substantially flat surface suitable for resting on an operating room table, an examination table, or a hospital bed. The upper side 124 includes a contoured portion 128 located between a first flat portion 130 and a second flat portion 132. As shown in FIG. 18, the upper side 124 of the non-slotted positioner 118 is also configured to support a patient's head when the patient is lying on his or her back (i.e., in the supine position). In addition to being positionable under a patient's head, the non-slotted positioner 118 can also be used to position other portions of a patient's body as found necessary by a clinician.

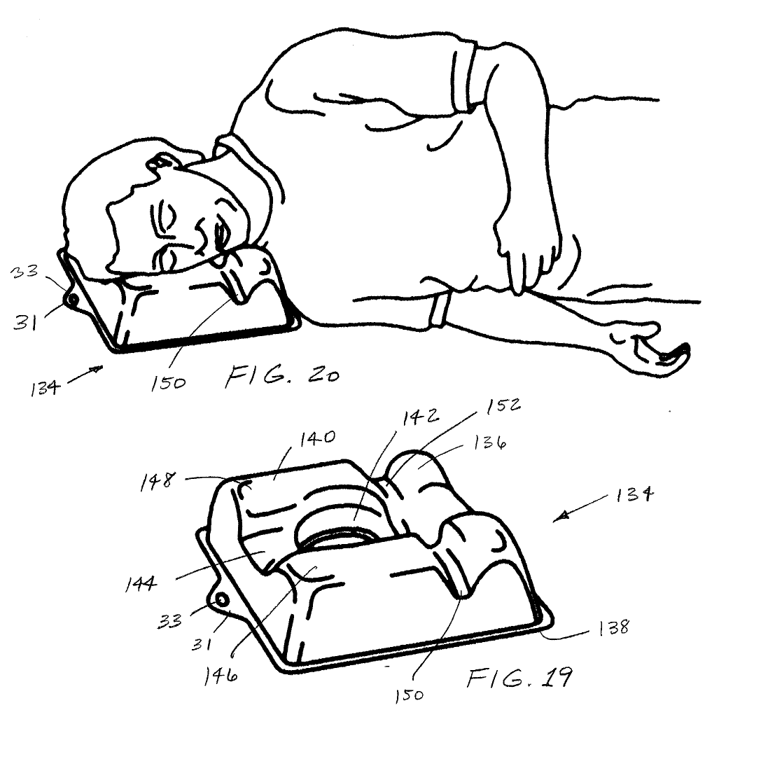

As shown in FIGS. 19 and 20, the patient-positioning device system 10 can also include a slotted positioner 134. The slotted positioner 134 includes a main portion comprised of a generally square or rectangular block of resilient material 136 having a bottom side 138 and an upper side 140. A circular aperture 142 is formed through the block of resilient material 136. The bottom side 138 has a substantially flat surface suitable for resting on an operating room table, an examination table, or a hospital bed. As shown in FIG. 20, the upper side 140 of the slotted positioner 134 is configured to support a patient's head. Specifically, the upper side 140 includes a contoured portion 144 located between a first flat portion 146 and a second flat portion 148. The slotted positioner 134 also includes a first elongated recess 150 and a second elongated recess 152, each one extending outwardly from the circular aperture 142. The first elongated recess 150 and the second elongated recess 152 are configured to receive breathing or drainage tubes (e.g., an endotracheal tube) that may be placed in the patient's nose or mouth, so that the patient's head can be positioned comfortably within the contoured portion 144 when the patient is lying on his or her side. In addition to being positionable under a patient's head, the slotted positioner 134 can also be used to position other portions of a patient's body as found necessary by a clinician.

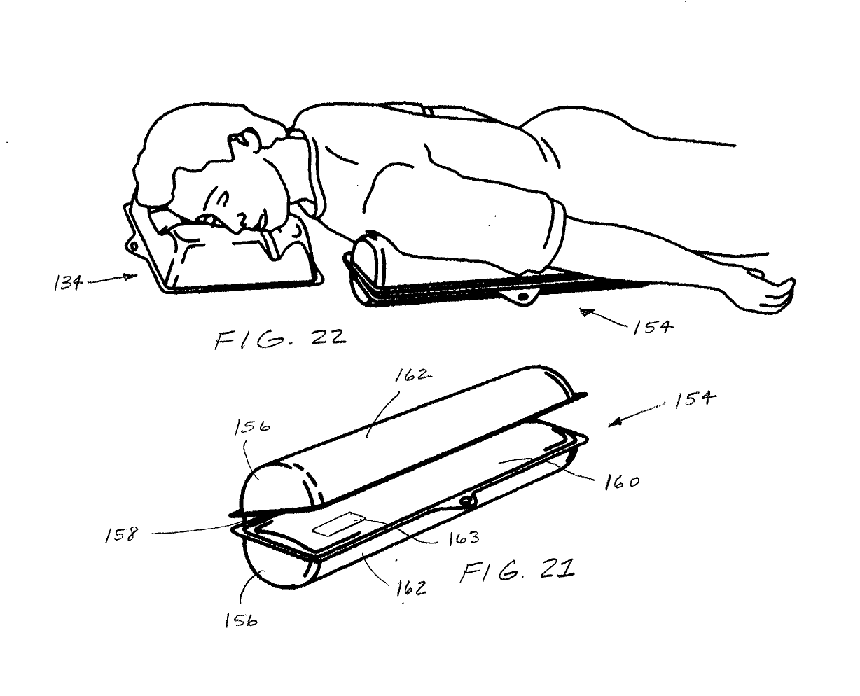

As shown in FIGS. 21 and 22, the patient-positioning device system 10 can also include a chest roll 154. The chest roll 154 includes a main portion comprised of two elongated blocks of resilient material 156. Each of the blocks of resilient material 156 has a generally hemispherical cross-section. The two blocks of resilient material 156 are joined together by a seal 158. The chest roll 154 has a continuous bottom side 160 and two hemispherical upper sides 162. The bottom side 160 of the joined blocks of resilient material 156 has a substantially flat surface suitable for resting on an operating room table, an examination table, or a hospital bed. The two blocks of resilient material 156 can also be folded about the seal 158 to form a cylindrical patient-positioning device, as shown in FIGS. 21 and 22. In addition, a clinician can cut along the length adjacent to the seal 158 to form two separate hemispherical patient-positioning devices. The upper sides 162 of the chest roll 154 are configured to support a patient's chest while the patient is lying on his or her stomach (i.e., in the prone position). As shown in FIG. 22, the clinician has folded the chest roll 154 about the seal 158 to form a cylindrical patient-positioning device and has placed the chest roll 154 under the patient's shoulder and arm. The clinician has also positioned a slotted positioner 134 under the patient's head. In addition to being positionable under a patient's shoulder and arm, the chest roll 154 can also be used to position other portions of a patient's body as found necessary by a clinician. For example, the chest roll 154 can be laid flat on the table or bed and positioned under the patient's chest, rib cage, or abdomen to relieve pressure from the patient's torso. The longitudinal lengths of the upper sides 162 of the chest roll 154 can be positioned parallel to or perpendicular to the longitudinal length of the patient's body. Also, the chest roll 154 can be cut along the length of the seal 158 and the two hemispherical patient-positioning devices can be positioned under the patient's knees.

In some embodiments, the patient-positioning device system 10 includes a family pack of patient-positioning devices 12 for use in a hospital or clinic with or without the storage rack 14. For example, the family pack can include one or more of any of the following patient-positioning devices in any suitable combination: the small or seven-inch bagel 16, the large or nine-inch bagel 18, the elbow protector 20, the heel protector 22, the non-slotted positioner 118, the slotted positioner 134, and chest roll 154. The family pack is particularly suitable for use with the storage rack 14 in an operating room.

The patient-positioning devices 12 are preferably designed to withstand approximately 1,000 uses per year and approximately 6,000 to 10,000 uses in total before having to be replaced. The patient-positioning devices 12 are preferably designed to each support approximately 20 to 40 pounds. However, the chest roll 154 is designed to support approximately 275 pounds.

A label 163 (e.g., as shown on the chest roll 154 in FIG. 21) can be included on each of the patient-positioning devices 12 in order to identify the intended use of the patient-positioning device 12. The label 163 can also include a part number identifying the particular patient-positioning device 12, so that the clinician can easily reorder the patient-positioning device 12. In addition, the label 163 can include a date on which the patient-positioning device 12 was manufactured in order to help the clinician determine when to replace the patient-positioning device 12.

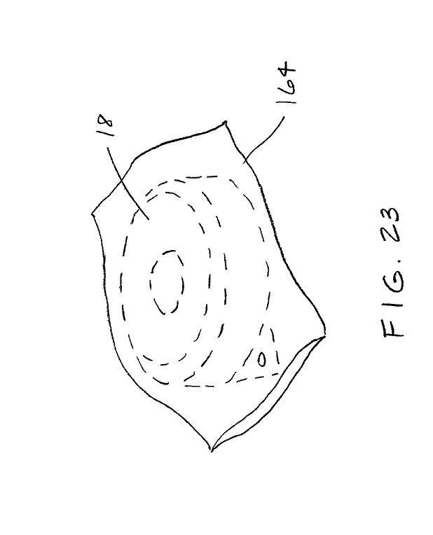

As shown in FIG. 23, the patient-positioning device system 10 can also include disposable protective covers 164 for the patient-positioning devices 12. The disposable protective covers 164 are preferably constructed of a breathable fabric, such as cotton or a cotton-blend. The disposable protective covers 164 are preferably open-ended sleeves of fabric, so that each one of the patient-positioning devices 12 (e.g., the large bagel 18 as shown in FIG. 23) can be slid into and out of the fabric cover. In general, the disposable protective covers 164 are provided to make the surface of the patient-positioning devices 12 more comfortable against the patient's skin. However, the patient-positioning devices 12 can be used with or without the disposable protective covers 164.

According to the method of the invention, the storage rack 14 is mounted to a wall at a convenient location in a room of a hospital or clinic, and a plurality patient-positioning devices 12 are hung on the prongs 15 of the storage rack 14. Before a clinician performs a medical procedure, the clinician removes one of the patient-positioning devices 12 from the storage rack 14. The clinician preferably covers the patient-positioning device 12 with one of the disposable protective covers 164. The clinician positions the patient-positioning device 12 under a portion of the patient's body. Once the clinician completes the medical procedure, the clinician removes the patient-positioning device 12 from under the portion of the patient's body. The clinician also removes and discards the disposable protective cover 164. If necessary, the clinician can also clean the patient-positioning device 12. The clinician then hangs the patient-positioning device 12 from one of the prongs 15 of the storage rack 14, preferably via its hanging tab 31.

Various features and advantages of the invention are set forth in the following claims.

What is claimed

1. A patient-positioning device comprising:
a main portion having
a first side configured to support a portion of a patient's body, and
a second side configured to rest on a surface; and
a hanging tab extending from the main portion.

2. The patient-positioning device of claim 1, wherein the patient-positioning device is reusable.

3. The patient-positioning device of claim 1, wherein the main portion is a block of resilient material.

4. The patient-positioning device of claim 3, wherein the resilient material is high-density, closed-cell foam.

5. The patient-positioning device of claim 1, wherein the main portion is encapsulated by a substantially impermeable cover.

6. The patient-positioning device of claim 5, wherein the substantially impermeable cover is constructed of vinyl.

7. The patient-positioning device of claim 6, wherein the vinyl is latex-free and contains antimicrobial agents to help prevent the growth of bacteria on the patient-positioning device.

8. The patient-positioning device of claim 5, wherein the hanging tab is integrally molded to the substantially impermeable cover.

9. The patient-positioning device of claim 5, wherein the substantially impermeable cover includes a first portion connected to a second portion via a seal, the seal having a width equal to or greater than approximately 0.12 inches in order to help prevent contaminates from being trapped in the seal.

10. The patient-positioning device of claim 5, wherein the substantially impermeable cover is imprinted with a label including at least one of (a) an intended use for the patient-positioning device, (b) a part number for reordering the patient-positioning device, and (c) a date on which the patient-positioning device was manufactured.

11. The patient-positioning device of claim 5, wherein the substantially impermeable cover is a bright color in order to help prevent against unintentional disposal.

12. The patient-positioning device of claim 1, wherein:
the first side of the main portion is contoured to support a portion of a patient's arm; and
a circular aperture configured to receive a patient's elbow is formed through the main portion.

13. The patient-positioning device of claim 1, wherein:
the main portion includes a medial portion, a first lateral support connected to the medial portion via a first offset portion, and a second lateral support connected to the medial portion via a second offset portion;
the first side of the main portion is contoured to support the lower calf and heel portions of a patient's leg; and
a circular aperture configured to receive a patient's heel is formed through the medial portion.

14. The patient-positioning device of claim 13, wherein a substantially impermeable cover encapsulates the medial portion, the first lateral support, and the second lateral support.

15. The patient-positioning device of claim 14, wherein the first offset portion and the second offset portion are each constructed of a sheet of substantially impermeable material.

16. The patient-positioning device of claim 14, wherein the hanging tab is integrally molded to the substantially impermeable cover on one of a side opposite to the first offset portion of the first lateral support and a side opposite to the second offset portion of the second lateral support.

17. The patient-positioning device of claim 13, and further comprising a securement strap connected to one of the first lateral support and the second lateral support and releasably coupleable to the other of the first lateral support and the second lateral support in order to secure the patient's heel within the circular aperture in the medial portion and in order to secure the first lateral support and the second lateral support around the lower calf and heel portions of the patient's leg.

18. A patient-positioning device system comprising:
a plurality of patient-positioning devices, each one of the plurality of patient-positioning devices including
main portion having
a first side configured to support a portion of a patient's body; and
a second side configured to rest on a surface; and
a storage rack from which each one of the plurality of patient-positioning devices can be hung.

19. The patient-positioning device system of claim 18, wherein each one of the plurality of patient-positioning devices is reusable.

20. The patient-positioning device system of claim 18, and further comprising a hanging tab extending from each one of the patient-positioning devices.

21. The patient-positioning device system of claim 18, wherein the main portion is a block of resilient material.

22. The patient-positioning device of claim 21, wherein the resilient material is high-density, closed-cell foam.

23. The patient-positioning device system of claim 18, wherein the main portion is encapsulated by a substantially impermeable cover.

24. The patient-positioning device of claim 23, wherein the substantially impermeable cover is constructed of vinyl.

25. The patient-positioning device of claim 24, wherein the vinyl is latex-free and contains antimicrobial agents to help prevent the growth of bacteria on the patient-positioning device.

26. The patient-positioning device system of claim 23, wherein the substantially impermeable cover includes a first portion connected to a second portion via a seal, the seal having a width equal to or greater than approximately 0.12 inches in order to help prevent contaminates from being trapped in the seal.

27. The patient-positioning device system of claim 23, wherein the substantially impermeable cover is imprinted with a label including at least a one of (a) an intended use for the patient-positioning device, (b) a part number for reordering the patient-positioning device, and (c) a date on which the patient-positioning device was manufactured.

28. The patient-positioning device system of claim 23, wherein the substantially impermeable cover is a bright color in order to help prevent against unintentional disposal.

29. The patient-positioning device system of claim 23, wherein a hanging tab is integrally molded to the substantially impermeable cover.

30. The patient-positioning device system of claim 18, wherein the plurality of positioning devices includes at least two of a seven-inch bagel, a nine-inch bagel, a non-slotted head positioner, a slotted head positioner, an elbow protector, a heel protector, and a chest roll.

31. The patient-positioning device system of claim 18, wherein:
the plurality of patient-positioning devices includes an elbow protector;
the first side of the main portion of the elbow protector is contoured to support a portion of a patient's arm; and
a circular aperture configured to receive a patient's elbow is formed through the main portion of the elbow protector.

32. The patient-positioning device system of claim 18, wherein:
the plurality of patient-positioning devices includes a heel protector;
the main portion of the heel protector includes a medial portion, a first lateral support connected to the medial portion via a first offset portion, and a second lateral support connected to the medial portion via a second offset portion;
the first side of the main portion of the heel protector is contoured to support the lower calf and heel portions of a patient's leg; and
a circular aperture configured to receive a patient's heel is formed through the medial portion.

33. The patient-positioning device system of claim 32, wherein a substantially impermeable cover encapsulates the medial portion, the first lateral support, and the second lateral support.

34. The patient-positioning device system of claim 33, wherein the first offset portion and the second offset portion are each constructed of a sheet of substantially impermeable material.

35. The patient-positioning device system of claim 33, wherein a hanging tab is integrally molded to the substantially impermeable cover on one of a side opposite to the first offset portion of the first lateral support and a side opposite to the second offset portion of the second lateral support.

36. The patient-positioning device system of claim 32, and further comprising a securement strap connected to one of the first lateral support and the second lateral support and releasably coupleable to the other of the first lateral support and the second lateral support in order to secure the patient's heel within the circular aperture in the medial portion and in order to secure the first lateral support and the second lateral support around the lower calf and heel portions of a patient's leg.

37. The patient-positioning device system of claim 18, and further comprising a disposable protective cover postionable over each one of the plurality of patient-positioning devices.

38. The patient-positioning device system of claim 37, wherein the disposable protective cover is an open-ended sleeve of fabric so that each one of the patient-positioning devices can be slid into and out of the fabric cover.

39. The patient-positioning device system of claim 18, wherein the storage rack is comprised of a base member mountable to a wall and a plurality of prongs connected to the base member, and each one of the plurality of patient-positioning devices can be hung on each one of the plurality of prongs.

40. The patient-positioning device system of claim 39, wherein each one of the plurality of patient-positioning devices includes a hanging tab, and each one of the plurality of patient-positioning devices can be hung on each one of the plurality of prongs via the hanging tab.

41. The patient-positioning device system of claim 39, wherein the storage rack includes a label including at least one of (a) a description of each one of the plurality of positioning devices, and (b) part numbers for reordering each one of the patient-positioning devices.

42. A method of using a patient-positioning device system to support a portion of a patient's body during a medical procedure, the method comprising:
providing a plurality of patient-positioning devices, each one of the plurality of patient-positioning devices including a hanging tab;
providing a storage rack from which each one of the plurality of patient-positioning devices are hung via the hanging tab;
removing at least one of the plurality of patient-positioning devices from the storage rack;
positioning the at least one of the plurality of patient-positioning devices under the portion of the patient's body;
removing the at least one of the plurality of patient-positioning devices from under the portion of the patient's body once the medical procedure is completed; and
hanging the at least one of the plurality of patient-positioning devices on the storage rack via the hanging tab.

43. The method of claim 42, and further comprising reusing the at least one of the plurality of patient-positioning devices in subsequent medical procedures.

44. The method of claim 42, wherein providing a plurality of patient-positioning devices includes providing at least two of a seven inch bagel, a nine inch bagel, a non-slotted head positioner, a slotted head positioner, an elbow protector, a heel protector, and a chest roll.

45. The method of claim 42, and further comprising positioning the at least one of the plurality of patient-positioning devices within a disposable protective cover before positioning the at least one of the plurality of positioning devices under the portion of the patient's body.
